(19) United States
(12) Patent Application Publication
(10) Pub. No.: US 2018/0206543 A1
(43) Pub. Date: Jul. 26, 2018

(54) CHEWABLE VITAMIN FORMULATION WITH NO ADDED SUGAR FOR THE PROMOTION OF SATIETY

(71) Applicant: BELT NUTRITION COMÉRCIO DE SUPLEMENTOS LTDA., Curitiba (BR)

(72) Inventor: Rodrigo Alexandre Alvez Camargo, Curitiba (BR)

(21) Appl. No.: 15/789,595

(22) Filed: Oct. 20, 2017

(30) Foreign Application Priority Data
Jan. 20, 2017 (BR) 102017001302-2

(51) Int. Cl. A23L 33/00; A23L 19/00; A23L 33/10; A23L 33/15

(52) U.S. Cl. CPC A23L 33/40; A23L 19/09; A23V 2002/00; A23L 33/15; A23L 33/10

(57) ABSTRACT

This disclosure relates to compositions with nourishing properties that provide satiety to the consumer, where the composition may further provide nutritional functions due to the vitamin input(s) of its formulation, associated to various components, including compositions where no added sugar is required, and/or where the compositions may provide an auxiliary alternative to the diet needs of consumers.

### FIELD OF THE DISCLOSURE

This disclosure relates to a food product, more specifically a chewable vitamin supplement, such as a supplement in candy or tablet form. The product may have no added sugar, and may include in its formulation the green plantain biomass and/or inulin as a fiber source.

### BACKGROUND

According to the National Health Surveillance Agency [ANVISA|Agência Nacional de Vigilância Sanitária], the names “candy” and “toffee” are used to denominate pastes with processed sugar as its base ingredient in various forms and featuring hard or semi-hard consistency, with or without addition of other allowed substances.

The “chewable candy” is different from the “hard candy” in its cooking process that is done in a lower temperature and higher percentage of humidity in the final product, as well as including fat in its formulation.

Thus, the “chewable candy” differs from the “hard candy” in its consistency due to higher crystallization of the latter, which becomes vitreous and brittle. The dough of the “chewable candy” may therefore be handled and drawn, in order to compound the final product.

In relation to the “drop candy”, the “chewable candy” is different in the manufacturing process, since the former is stored in different compositions, such as jelly, pectin, gum, etc., or, further, in hard or crystallized forms.

The challenge, however, is to manufacture a vitamin supplement in “chewable candy” form, which does not require added sugar and, simultaneously, provides satiety to the consumer in a stable and palatable presentation.

Document PI0410516-8 shows a food product with a lipid as a satiety agent, encapsulated by proteins or carbohydrates and at least 2% in protein weight, where the satiety agent is released from the encapsulation material in the intestinal tract of the individual. It does not feature, therefore, the characteristic of being chewable or the use of fibers as a satiety agent, differing substantially from the formulation proposed in this innovation.

Document PI 0410516-9 shows a food product with a lipid as a satiety agent, with an average particle size ranging from 1 μm to 250 μm, encapsulated by proteins or carbohydrates and at least 2% in protein weight, where the satiety agent is released from the encapsulation material in the intestinal tract of the individual. It does not feature, therefore, the characteristic of being chewable or the use of fibers as a satiety agent, differing substantially from the proposed formulation.

Document PI 0412626-2 shows an edible liquid or pasty composition, comprising protein and a non-denaturized or hydrolyzed biopolymer thickening agent with a gastric viscosity at 0.1/s and 37° C. of at least 20 Pa·s and, furthermore, in which the gastric viscosity is higher than the composition viscosity. It does not feature, therefore, the characteristic of being chewable or the use of fibers as a satiety agent, differing substantially from the proposed formulation.

Document PI 0412633-5 shows an edible liquid aqueous composition or consumable by spoon, containing protein and a biopolymer thickening agent which is not denaturized or hydrolyzed, in which the composition has a gel strength at 37° C. and pH 2 of at least 10 KPa. It does not feature, therefore, the characteristic of being chewable or the use of fibers as a satiety agent, differing substantially from the proposed formulation.

Document PI 1103739-3 shows an instant meal type food composition ready for consumption, which induces satiety and comprises carbohydrate and/or protein and/or vegetable sources, enriched with bioactive compounds, for example, fructans, inulin, as well as carotenoids such as β-carotene, lutein, lycopene and/or antioxidant compounds. It does not feature, therefore, the characteristic of being chewable or the use of fibers as a satiety agent, differing substantially from the proposed formulation.

Document PI 0620972-6 shows a food product enriched in chewable calcium, capable of providing daily Recommended Dietary Allowance (RDA) of elementary calcium, and may also provide Vitamin D3. It does not feature, therefore, the characteristic of providing satiety through use of fibers, differing substantially from the proposed formulation.

Document WO03035027 shows a chewable pill containing at least one vitamin, optionally, at least one mineral, lysine or a derived pharmaceutically acceptable salt, at least one sweetener, optionally at least one flavoring to disguise the unpleasant taste of lysine and a pharmaceutically or dietetically acceptable vessel. It does not feature, therefore, the characteristic providing satiety through use of fibers, differing substantially from the proposed formulation.

Document U.S. Pat. No. 6,455,068 shows a chewable dietary fiber tablet, comprising a water-soluble gelling inulin as a dietary fiber source. It does not anticipate neither the use of fibers to promote satiety nor the association of the proposed formulation.

Document U.S. Pat. No. 8,613,971 shows a complex that comprises a hydrothermally treated starch associated to a hydrocolloid, said complex prepared by extrusion using heat and/or pressure. It does not anticipate neither the use of fibers to promote satiety nor the association of the proposed formulation.

Document US20100303961 shows a method to induce satiety in human individuals, comprising the administration of a food product with a microalgae biomass, combined with one or more edible ingredients. Therefore, it does not anticipate the use of fibers as a satiety agent.

Document US20150098978 shows a chewable tablet, comprising a solid solution made of soluble fibers, and one or more sugar alcohols with a vitreous transition temperature lower than 40° C. associated to one or more additives dispersed in the solid solution. Although the document provides the use of fibers combined with sweeteners, it does not provide neither the promotion of satiety nor the combination of the proposed formulation.

Document US20160242450 shows a method for promoting satiety in an individual, comprising the provision to an individual of a food composition for consumption in association with a diet, meal or snack, in order to promote satiety, in which the food composition comprises: an edible gelling agent, water and a dietary protein or dietary fiber. Although a formulation for promotion of satiety is provided, it is not based on using a fiber to achieve this objective, and does not approach a formulation as proposed herein.

Document U.S. Pat. No. 9,253,991 shows a chewing gum that comprises a liquid or semi-liquid active ingredient, such as vitamins, sugars or alcohols, caffeine, among others. Although the product provided in the document is intended to the promotion of satiety, it does not embody a similar formulation to that provided in the proposal.

Document CN102429234 shows a chewable pill made of burdock dietary fibers, vitamin C, flavoring agent, natural fragrance and similar ingredients.

Product “Modere SatietyChews”, which may be seen in https://www.modere.com/productdetail/satiety-chew, relates to a chewable candy that provides satiety. It does not provide, however, the proposed formulation.

Product “BeautyCandy”, which may be seen in http://www.beautyin.com/alimeticos/beautycandy, relates to a collagen and vitamin-based chewable candy. It does not provide, therefore, the formulation proposed herein.

### DETAILED DESCRIPTION

This disclosure relates, in some aspects, to a formulation of a chewable vitamin complex, with no added sugar, preferably featured in a candy or tablet form, where the source of fibers is through use of green plantain biomass and inulin.

The “chewable candy” that is object of examples of this disclosure may be made of or including green plantain biomass, which has a low glycemic index and may be recommended to complement the diet of diabetic, obese and celiac individuals, and may contain vitamins and minerals with antioxidant properties, associated to the reduction of LDL cholesterol levels and triglycerides.

The B complex vitamins are important to neural functioning, improve hair and skin aspect, have anti-inflammatory effects and act in preventing anemia and skin injuries. Vitamin C is an antioxidant, acts upon the immunological system, synthesizes the collagen and improves absorption of iron and vitamin D, which is essential to bone health.

Further, the formulation of this disclosure may be free of gluten, may be free of additional sugars and/or lactose, and/or may comprise the use of natural flavors and/or coloring.

To manufacture a chewable candy without adding sugar is a major challenge to the food industry, as it is extremely difficult to reach the ideal dough point, in which the candy does not stick or sweat out, without requiring the use of an important stabilizer in the industry—sugar.

The example formulations presented herein manage to fulfill expectations of a product without added sugar, where these may also provide a low amount of calories and may also be enriched with vitamins.

Example ingredients used in the example formulations may have different roles, as follows: a) Maltitol, in syrup or powder form, is a sweetener similar to sucrose and grants a high amount of solid to the product; without this ingredient, example mixes do not form into candy, but into a liquid mixture unable to thicken; b) Isomalt is a mixture of two alcohols that, aside from sweetening properties without leaving residue, also favors texture and is a source of solids for the chewable candy; c) Jellies are able to solidify in contact with water, granting texture to the final product; it is dissolved in hot water prior to being added to the dough of the final product; d) Hydrogenated vegetable fat (low trans) is important to grant a soft texture to the chewable candy, granting “chewability” and endurance to the product; “low trans” is a denomination of solid vegetable fat (hydrogenated) which has low amount of trans positions in its chain; e) Soy lecithin is a gum that is capable of incorporating water, as well as providing a soft texture to the product; f) Green plantain biomass is an ingredient which grants a high amount of resilient starch, that is slowly digested by the body, as well as having a low glycemic index and, further, being associated to reduction of LDL cholesterol levels; g) An inulin-based mix of vitamins provides vitamin input at levels suitable and allowed to the product, where inulin is a carbohydrate with physiological characteristics analogous to fibers, in other words, are not affected by digestive enzymes, but feature water soluble properties and are fermentable, and, therefore, feature the ability to mold the microbiota of the gastrointestinal tract (GIT) and increase proliferation of beneficial bacteria, reducing the population of pathogenic bacteria and concentration of toxic metabolites, as well as contributing to preventing diarrhea and constipation; h) Natural flavors provide the product with an expectation of flavor, for example, banana or chocolate, among others; i) Turmeric coloring provides the product with an orange-yellow tone.

In this way, the formulations proposed in this disclosure may not require added sugar to provide acceptable taste (and in some examples, it is expressly envisions that there is no added sugar or sugars). Sugar additives may be replaced with polyols, which act as sweeteners, such as maltitol and isomalt, and which are also part of the candy matter. Isomalt, on a side note, includes features that grant hardness to the formed candy matter. Thus, the relationship between maltitol and isomalt defines the texture of the candy to be produced.

In order to grant the desired satiety, one or more a complex carbohydrates are employed, such as a resilient starch with long digestibility. The embodiments described herein use green plantain biomass in the example formulations, which may comprise of a mix of green plantain, citric acid acidifier and potassium sorbate. Alternatively, as another example, the green plantain flour may replace this biomass.

Further, the formulation may incorporate the use of vegetable fat, in order to improve candy texture and formulation behavior inside mixture and manufacturing equipment. Alternatively, another type of fat may be used, such as palm fat or butter oil, which is an anhydrous milk fat, obtained from cream or butter after all water and non-fat solids are eliminated, through technologically suitable processes.

The use of vitamins in the formulation may grant the advantage of nutritional power from said substances to the final product. Any desired combination may be used, according to dietary needs of the consumer.

The use of jelly or pectin may grant elasticity to the candy matter.

Natural stabilizers, such as soy lecithin, may be used to grant stability to the formulation. Alternatively, it may be replaced with mono and diglycerides from oily acids.

The use of natural colorants, such as turmeric, may allow adjusting the appearance of the matter to a pleasant coloration. The use of acidifiers, such as citric acid or lactic acid, may adjust the candy flavor. Use of natural flavors may provide the particular flavor or a particular flavor of the candy, according to various possibilities available at the market, such as chocolate, fruit or others.

In a preferred configuration, the formulation features the following generic composition:

TABLE 1
GENERIC FORMULATION OF THE BANANA FLAVORED
CHEWABLE VITAMIN
FLAVORED CHEWABLE VITAMIN

| Ingredient | Amount (% in mass) |
|---|---|
| Maltitol syrup (76° Brix) | 36.9344 |
| Powdered isomalt | 20.7756 |
| Powdered isomalt 90 u | 4.3860 |
| Powdered maltitol | 20.7756 |
| Jelly | 2.7701 |
| Mix of vitamins | 0.6925 |
| Hydrogenated vegetable fat | 4.1551 |
| Soy lecithin | 0.0462 |
| Green plantain biomass | 8.4257 |
| Natural banana flavor | 0.6925 |
| Turmeric | 0.3463 |

The maltitol syrup and powdered maltitol are both products that provide solid substances to the candy, as well as acting as sweeteners. Their basic difference is the physical state. The powdered maltitol is featured as a white, crystalline and anhydrous powder, in other words, without water. Maltitol syrup, on the other hand, has almost 25% water in its composition, and may be used to mix and homogenize ingredients.

Isomalt and 90u isomalt are alcohols which act as sweeteners, and their basic difference is that the 90U product has a much smaller grain size that standard isomalt. Its function in the product is also to provide solid substance and act as a sweetener to the candy.

This innovation is not limited to the representations commented or illustrated herein and should be comprised in its full scope. Many modifications and other representations may be perceived by those skilled in the art to which this disclosure is included, with the benefit of the knowledge provided in previous descriptions. Furthermore, it is understood that the disclosure is not limited to the specific forms presented, and that modifications and other forms are considered part of the scope of the attached claims. Although specific terms are used herein, these are only used in a generic and descriptive manner, not with limiting purposes.

1. A formulation comprising:
a) 36 to 98% mass of one or more complex carbohydrates;
b) 0.5% to 6% mass of one or more vegetable fats;
c) 0.1% to 6% mass of at least one vitamin;
d) 0.8% to 4% mass of one or more elasticity additives;
e) 0.01% to 3% mass of one or more stabilizers;
f) 0.05% to 10% mass of one or more natural colorings;
g) 0.15% to 0.8% mass of one or more acidifiers; and
h) 0.09% to 1.2% mass of one or more natural flavors;
wherein there is no sugar added to the formulation.

2. The formulation according to claim 1, wherein the one or more complex carbohydrates comprise green plantain biomass.

3. The formulation according to claim 1, wherein the one or more complex carbohydrate comprise green plantain flour.

4. The formulation according to claim 1, wherein the one or more vegetable fats comprise palm fat.

5. The formulation according to claim 1, wherein the one or more vegetable fats comprise coconut fat.

6. The formulation according to claim 1, wherein the one or more vegetable fats comprise butter oil.

7. The formulation according to claim 1, wherein one or more elasticity additives comprise pectin.

8. The formulation according to claim 1, wherein the one or more stabilizers comprise one or more mono glycerdies of oily acids, one or more diglycerides of oily acids, or a combination thereof.

9. The formulation according to claim 1, wherein the one or more natural colorings comprise turmeric.

10. The formulation according to claim 1, wherein the one or more acidifiers comprise citric acid.

11. The formulation according to claim 1, wherein the one or more acidifiers comprise lactic acid.

12. The formulation according to claim 1, wherein the one or more elasticity additives comprise one or more jellies.

13. The formulation according to claim 1, wherein the formulation is a chewable vitamin.

14. The formulation according to claim 1, wherein the one or more stabilizers are natural stabilizers.
